(19) United States
(12) Patent Application Publication
(10) Pub. No.: US 2004/0050773 A1
(43) Pub. Date: Mar. 18, 2004

(54) Filters with a graduated structure and a method for producing the same

(76) Inventors: Peter Neumann, Remscheid (DE); Simon Steigert, Radevormwald (DE); Martin Kurt Bram, Julich (DE); Hans-Peter Bruchkremer, Heinsberg (DE); Zi Li, Wuppertal (DE); Li Zhao, Siegen (DE)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/624,616

(22) Filed: Jul. 21, 2003

Related U.S. Application Data
(63) Continuation of application No. PCT/EP02/00232, filed on Jan. 12, 2002.

(30) Foreign Application Priority Data
Jan. 19, 2001 (DE) 101 02 295.6-27

(51) Int. Cl. B01D 39/20

(52) U.S. Cl. 210/490; 210/500.1; 210/510.1; 264/43

(57) ABSTRACT

The aim of the invention is to provide filters with a graduated structure, which are simple to produce and exhibit excellent properties in terms of their permeability to liquids and/or gases. To achieve this, the filters are produced from sinterable material consisting of at least two layers of differing pore size, a first layer having a minimum pore size of 0.005 μm and consisting of metal oxide or mixtures of metal oxide and the additional layer that is connected to the first layer consisting of a material other than metal oxide. The invention also relates to a method for producing the inventive filters and to the use thereof.

This is a continuation of PCT/EP02/00232, filed Jan. 12, 2002, which claims priority to German Application No. 101 02 295.6 filed Jan. 19, 2001.

### SUMMARY OF THE INVENTION

The present invention concerns filters with a graduated structure, produced from sinterable material consisting of at least three layers of differing pore size, as well as a method for their production and use.

In order to manufacture sintered filter bodies known in the art is to produce mixtures from metal powder and binding agents to obtain a so-called green body and to press these mixtures into the required shape under a pressure of up to some 1.000 bar. Subsequently, the green bodies produced this way are sintered at temperatures of up to more than 1,000° C. However, by this way, only filter bodies with a coarse porosity can be well produced. The production of fine filters with defined pore sizes would create products with very low values for the permeability, which are practically useless.

However, there is a need for very fine pored filter bodies. To produce such fine pored filter bodies it is necessary to use especially fine metal powders having particle sizes within the nanometre range. The use of such metal particles however is problematic as these are easily inflammable on the one hand and on the other they are especially strong exposed to possible oxidation. Therefore, it is very difficult and complicated to use such metal powders in techniques. Furthermore, they are commercially not available for larger quantities.

A further problem with fine pored filter bodies is that the more fine pored a filter body is, the higher is its flow resistance. However, for the use of filters, for example in chemical systems, high flow resistances are not desired, as this requires higher pressures and thus more energy.

Therefore, it is the object of the present invention to provide for filters with a graduated structure, which do not show the mentioned disadvantages.

This problem is solved by a filter with a graduated structure, manufactured from sinterable material consisting of at least two layers of differing pore size, whereby the pore size of the first layer is in a range of 0.01 μm to about 1 μm and its layer thickness in a range of about 0.5 to 50 μm and it is made of metal oxide or mixtures thereof, whereby the second layer is made of a metallic material and its layer thickness is in a range of 5 to 300 μm, and whereby the third layer consists of a coarse porous supporting body made of a metallic material, whereby the penetration depth of the metal oxide material of the first layer into the second layer is in a range of one to five pore plies and the pore size of the first layer is ⅓ to ⅙ of the pore size of the second layer and the viscosity of the suspension used to produce the first layer is in a range of 0.003 to 0.96 pas. The second layer shows larger pores.

The filters according to the invention favourably show defined transitions between the at least two existing layers. Defined transition in the sense of the invention means, that the transition area in particular between the first and the second layer is narrow, whereby its width can be adjusted. Preferred the width of the transition area is between the first (metal oxide) layer and the second layer, i.e. the penetration depth of the metal-oxide material into the large-pored second layer is in a range of 2 pore plies. With the filters produced according to the invention it is advantageously possible to manufacture graduated filters with a de-fined flow resistance via the afore mentioned parameters. Graduated filters constructed in this way show flow rates of 1 to 1,500 m³/hm² for gases as, for example air at a differential pressure of approximately 100 millibar. Fluids as for example water show flow rates of approximately 10 to 30 m³/hm² at the same differential pressure. The permeability coefficient is approximately 0.002×10-12 to 3×10-12 m² at a total thickness of the layer of less than 100 μm, measured according to DIN ISO 4022. They show a bubble-point pressure in a range of approximately 8×106 to 2×10³ Pa, especially preferred in a range of about 8.6×106 to 1.72×10³ pa, measured according to DIN 30 911. The used metal oxides can easily be processed, as in finely diffused form they are not subject to inflammation or further oxidations. Furthermore, they are available as mass products. Thus, the manufacture of these graduated filters produced according to the invention is cost-efficient.

Preferred, the thickness of the second layer is in a range of 5 to 20 μm. The metallic powders used to produce the second layer still have particle sizes, which can be used for the production of the layer without any problems. The grain size and thus, the diameter of the powder particles usable in this case is in a range of about 0.05 μm to 150 μm, preferably in a range of 0.5 μm to 100 μm, even more preferred in a range of 0.5 μm to 6 μm. Opposed to that the metal oxide powders used to produce the first layer have particle sizes with a grain size lying in a range of about 0.001 μm to 0.1 μm, preferred 0.01 to 0.3 μm. Preferred, the filters with a graduated structure show a pore size decreasing in flow direction, i.e. the layer made from metal oxide is located on the inflowing side.

‘Sinterable materials’, which can be used for the second layer bonded with the first layer, mean powders or fibres or wires produced from metals, ceramics and/or plastics. Usable metallic materials are not only powders made from pure metals, but also powders made from metal alloys and/or powder mixtures from different metals and metal alloys. These comprise in particular steels, preferably chrome-nickel steels, bronzes, nickel master alloys as Hastalloy, Inconel or suchlike, whereby powder mixtures also can contain high-melting elements, as for example platinum or suchlike. The used metal powder and its particle size depends on the respective purpose of use. Preferred powders are the alloys 316 L, 304 L, Inconel 600, Inconel 625, Monel and Hastalloy B, X and C.

According to the invention the pore size of the first layer of the filters with a graduated structure is in a range of about 0.05 μm to about 0.6 μm. The thickness of this first layer should be in a range of about 0.5 to 10 μm. Because, the thinner the first layer, the lower the flow resistance for gases and/or fluids in case of this small pore size.

Preferably, the metal oxide or mixtures thereof is selected from a group comprising reducible and/or non-reducible metal oxides. Reducible oxides in the sense of the present invention are metal oxides, which are reducible to the respective metal within a reducing hydrogen atmosphere. Preferred hereby are metal oxides or mixtures of the same selected from a group comprising AgO, CuO, Cu2O, Fe2O3, Fe3O4 and/or NiO. Oxides, being difficult to reduce in the sense of the present invention on the other hand are oxides, which cannot be reduced in technical atmospheres, especially hydrogen. Preferred hereby are oxides selected from a group comprising TiO2, Al2O3, ZrO2, Cr2O3, MgO, CaO and/or SiO2.

If the first layer of the filters produced according to the invention is produced from metal oxides being difficult to reduce, this layer will after the sintering process consist of the respective metal oxide. The particle form of the used non-reducible metal oxides is preserved during the sintering process.

Preferred, a layer of mixed oxides is allocated between the first layer and the second layer. This can be formed by solid-state reactions with the oxide skin of the second metal layer, whereby the bond of the oxide layer to the underground is granted. This does not influence the quality of the filter. Such filters with a graduated structure having a first layer made from non-reducible metal oxides show excellent properties as to their flow resistance because of the exactly defined transition areas, otherwise they show excellent values respecting their ductility and impact strength, which is mainly achieved by the metallic supporting body (third layer). In this way it is possible to supply long-life and back-washable graduated filters. Their tensile strength is preferred within a range of about 5 to 500 N/mm², preferred 20 to 400 N/mm², according to DIN EN 309116. In addition, due to the good bond of the first to the second layer the use of the filters produced according to the invention permits pressures of up to 8 bar during the backwashing, which cannot be achieved with plastic membranes.

If the first layer is manufactured from reducible metal oxides, these are reduced to the respective metal during the sintering process in reducing hydrogen atmosphere. This makes it possible to provide pure metallic, graduated filters in a simple way, especially for micro filtration, if the second layer and the supporting body (third layer) has also been produced from metallic powders.

Furthermore, the present invention concerns a method of producing the filters with a graduated structure according to the invention, whereby in a first step a suspension containing metal oxides is applied onto an existing layer and subsequently it is sintered in a second step. Hereby, the layer can be applied by pouring, silk screen printing or immersion into the suspension or spraying. However, preferred it is applied by spraying of the metal oxides containing suspension.

Furthermore, the already existing layer is also preferred produced by spraying of a suspension containing sinterable materials and by a subsequent sintering of the same.

The method used to apply the suspension containing metal oxide, i.e. sinterable materials is here called ‘wet powder spraying’. Hereby, a suspension of the respective metal oxide, i.e. sinterable material is used, which also comprises solvents as well as further auxiliary substances. Hereby, the mixture ratio between the metal oxide i.e. sinterable material on the one hand and the solvent used in the suspension on the other hand is preferred at about 2:3. The suspension can be applied with a modified airgun, which is mounted onto an X-Y-moving system. After the suspension has been applied, the solvent is evaporated, or due to its low vapour pressure it evaporates by itself, and subsequently, the respective layer is sintered.

The method of wet powder spraying advantageously allows to use only a low volume percent of binding agents, so that no open structure exists between the particles of the layer. This guarantees that the gases developing during the sintering process, which follows the application of the suspension, completely and unimpeded remove the decomposing binding agent from the green body.

Basically, the sintering process comprises two steps, the first step of which is to decompose the used binding agent and the further step is the actual sintering process. The de-composition process itself is not limited to special time-temperature programmes. Typically, in a decomposition process the green body is step by step heated up to a temperature in a range of 280 to 420 at a rate of 3 to 10/min and depending on the size of the filter body, held at this temperature for a certain time period until the binding agent has been completely removed. Subsequently, the graduated sintering body is further heated up until the necessary sintering temperatures of 800 to 1,250 are reached, which depend on the material and its grain size.

The decomposition process as well as the actual sintering process are in case of using reducible oxides, carried out with protective gas (such as H2, N2, Ar and/or mixtures thereof) or in a vacuum.

Preferably, in case of the method according to the invention the existing layer is smoothed mechanically before the first layer is applied. Hereby, the smoothing can be done by mechanic dwell pressing by means for example of a calender. A calibrating can also be achieved by a simple rolling. Furthermore, the supporting body can be smoothed mechanically before applying the existing layer. The advantage of the mechanic smoothing is that this improves the bonding properties of the first layer on the next layer.

Preferred, the suspension containing metal oxide furthermore comprises solvents, binding agents, stabilizers and/or dispersing agents. Especially preferred solvents are selected from a group comprising water, methanol, ethanol, isopropanol, terpenes, C2-C5-alkenes, toluenes, trichlorethylenes, diethyl ether and/or C1-C6-aldehydes and/or ketones. Preferred are hereby solvents, which can be evaporated at temperatures below 100° C. The quantity of the used solvent is in a range of about 40 to 70 weight percent, referred to the used sinterable material i.e. metal oxide, preferred in a range of about 50 to 65 weight percent. Preferred, the sol-vent is selected in a way that the spraying drops caused when the solvent is applied, do not yet dry partly or completely during the spraying process itself before contacting the existing layer i.e. supporting body. Therefore, the use of sol-vent mixtures is preferred. Preferred hereby are mixtures from alcohols and terpenes, especially from ethanol and terpineol, especially such mixtures with viscosities in a range of about 0.006 to about 0.016 pas, or mixtures from alcohols and low ketones, especially methyl ethyl ketone.

The binding agent contained in the suspension containing metal oxide is preferred selected from a group comprising polyvinyl acetate, waxes, shellac, polyethylene oxides and/or polyglycoles. Polyalkylen oxides and -glycoles are preferably used as polymers and/or copolymeres with medium molecular weights in a range of 100 to 500,000 g/mol, preferred 1,000 to 350.000 g/mol, further preferred 5,000 to 6,500 g/mol. The binding agents are preferred used in a quantity in a range of about 0.01 to 12 weight percent, preferred in a range of 2 to 5 weight percent, in each case referred to the total quantity. Especially preferred is however, to apply the layer containing metal oxide without a binding agent. Hereby, the decomposition process, which may be necessary in some cases, can be omitted. Alternatively, it is also possible to deposit the particles during the spraying process by electrostatic charging of the body on which they shall be applied, or of the powder or of both.

The suspension containing the metal oxide preferably has a stabilizer, selected from a group comprising organic and/or inorganic acids, inorganic lyes, polyacrylamides, polyacryl acid and/or amines. Hereby, especially preferred are ethanoic acid, citric acid, hydrochloric acid, oxalic acid, lithium hydroxide, ammonium hydroxide, triethan diamine and tetramethyl ammonium hydroxide. Especially preferred is the use of ethanoic acid. The quantity of the used stabilizer is in a range of about 3 to 13 weight percent, referred to the total quantity, further preferred in a range of 5 to 8 weight per-cent. By adding the afore mentioned stabilizers the trend of the fine oxide particles to agglomerate is reduced, which effects an even surface and pore distribution.

Furthermore, the suspension containing metal oxide preferred comprises a dispersing agent, selected from a group comprising polyamines, phthalic esther and/or polyethylenimines. Especially preferred are hereby polyamines, selected from the group of the polyethylenimines. By adding a dispersing agent, especially polyethylenimines, the viscosity of the metal oxide suspension to be sprayed can be adjusted perfectly. Preferred viscosities of the suspension lie in a range of about 0.005 to about 0.008 Pas.

With the help of the method according to the invention it is possible to produce graduated filters, which have excellent properties as to their flow capabilities, especially low flow resistances, which is in particular due to exactly defined transitions between the respective layers of the graduated filters, such as, moreover to produce such graduated filters safely, as the dangers of inflammation and oxidation are nearly eliminated.

Furthermore, the present invention concerns the use of graduated filters with the afore mentioned properties for the filtration of coolants, lubricants and purifying agents, for extra-fine separation of catalyst particles, in membrane reactors, as filtering candle and/or filtering tube, in food and beverage industries, laboratory technology, medicine technology, environmental technology and/or as cross-flow-filter for the micro or ultra filtration. Especially, the graduated filters produced according to the invention are used in filtering tubes and candles, which may have a length of 10 mm to 1,500 mm. Hereby, the candles can also have coatings on the front side.

These and further advantages of the invention are presented in the following figures and examples.

### BRIEF DESCRIPTION OF THE DRAWINGS

FIG. 1 a highly magnified copy of a cross section through a filter produced according to the invention.

### DETAILED DESCRIPTION OF ILLUSTRATIVE EMBODIMENTS

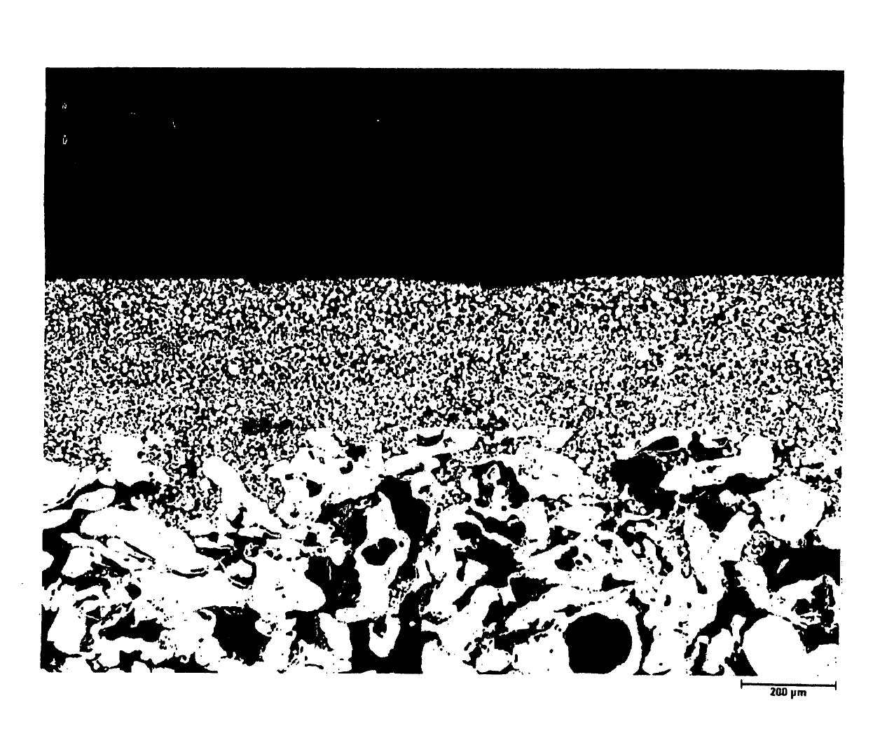

FIG. 1 shows a filter produced according to the invention marked with the reference number 1. This shows a first layer 2 made of TiO2 with a medium grain size of 0.45 μm, a further sintered layer 3, made of stainless steel (material sign 316L) with a medium grain size of less than 20 μm, as well as a coarse-porous supporting body 4, made of stainless steel 316L with a medium grain size in a range of 86 μm to 234 μm. The powder particles of the layer 2 penetrate into the layer 3 up to a depth of about 2 pore plies, which corresponds to about 3 μm and thus effects a good bonding of the layer. A mixed oxide layer, consisting of Cr0.12T0.780174 (determined by means of an X-ray spectrum) having a thickness of 2 pore plies is located between the first layer 2 and the next layer 3. The very sharp and defined transition from the first layer 2 to the next layer 3 can be clearly identified.

Assuming a standard suspension of metal oxides in a solvent, which contain 40 g of TiO2 and 60 g of ethanol, the following metal oxide suspensions were produced:

| | | |
|---|---|---|
| 1.: | 40.0 g | TiO2 |
| | 42.0 g | Ethanol |
| | 18.0 g | Terpineol |

In case of the afore mentioned suspension 1 it is guar-anteed, that the metal oxide suspension does not dry partly and completely while being sprayed onto and be-fore contacting an existing layer, which may also be a supporting body. This prevents in particular that the metal oxide layer to be applied shows noncoherent areas and is thus shaped irregularly after the sintering process, which causes an uneven porosity over the complete surface.

| | | |
|---|---|---|
| 2.: | 40.0 g | TiO2 |
| | 37.3 g | Ethanol |
| | 16.0 g | Terpineol |
| | 7.9 g | Ethanoic acid |

Due to the adding of the stabilizer ethanoic acid, the fine metal oxide particles suspended in the suspension 2 do nearly not tend to agglomerate, which effects an especially uniform distribution of the same onto the layer to be sprayed.

| | | |
|---|---|---|
| 3.: | 40.0 g | TiO2 |
| | 37.3 g | Ethanol |
| | 16.0 g | Terpineol |
| | 6.7 g | Ethanoic acid |
| | 1.2 g | Polyethylenimine |

The afore mentioned suspension 3 shows an optimum viscosity in a range of about 0.005 to 0.008 Pas, by which best results are achieved referring the spraying process, when the metal oxide suspension is applied onto a second layer by means of a modified airgun.

Particularly important is that the suspensions 1 to 3 do not contain any binding agent. This favourably allows to conduct the method according to the invention without a decomposition process, which saves costs especially because the sintering process can thus be carried out quicker and easier.

The suspensions 1 to 3 were sprayed onto a second layer manufactured by the procedure of wet powder splashing. Hereby the second layer consisted of a steel powder, which had a medium particle diameter of less than 5 μm. This second layer had a thickness of about 15 μm. The further layer was sintered in a sintering furnace at temperatures of less than 950° C. Subsequently, the metal oxide suspensions 1 to 3 were applied onto the second layer by means of a modified airgun, which is mounted onto an X-Y moving system. The layer was dried in a desiccator for 4 hours and subsequently sintered under a protection gas atmosphere or a vacuum in a range between 800° C. and 1,050° C., preferred about 850° C. to 950° C.

The filters produced by means of the method according to the invention have excellent properties as to the flow capability of fluids and/or gases. The reason for this is especially, that between the first and the second layer there is an exactly defined transition area, in which the flow resistance increases rapidly. This is due to the fact that the metal oxide particles in the first layer do not penetrate into the open pores of the second layer while being applied by means of the method according to the invention (wet powder spraying without binding agent). The second and the next layers can, if necessary, be produced by use of binding agents.

What is claimed:

1. A filter having a graduated structure, comprising at least a first, a second, and a third layer each having a different pore size, wherein:
the filter is manufactured from sinterable materials;
the pore size of the first layer is within a range of approximately 0.01 μm to approximately 1 μm;
a thickness of the first layer is within a range of approximately 0.5 μm to approximately 50 μm;
the first layer is formed from one of a metal oxide material and a mixture comprising a metal oxide material;
the second layer is formed from a metallic material;
a thickness of the second layer is within a range of approximately 5 μm to approximately 300 μm;
the third layer comprises a coarse and porous supporting body formed from a metallic material;
the metal oxide material of the first layer penetrates into the second layer to a depth of approximately one to approximately five pore plies;
the pore size of the first layer is approximately ⅓ to approximately ⅙ of the pore size of the second layer; and
the first layer is formed using a suspension having a viscosity within a range of approximately 0.003 pas to approximately 0.96 pas.

2. The filter of claim 1, wherein the pore size of the first layer is within a range of approximately 0.05 μm to approximately 0.6 μm.

3. The filter of claim 1, wherein the one of a metal oxide material and a mixture comprising a metal oxide material is selected from a group comprising reducible metal oxides and metal oxides that are difficult to reduce.

4. The filter of claim 3, wherein the metal oxides that are difficult to reduce are selected from a group comprising TiO2, Al2O3, ZrO2, Cr2O3, CaO, MgO and SiO2.

5. The filter of claim 3, wherein the reducible metal oxides are selected from a group comprising AgO, CuO, Cu2O, Fe2O3, Fe3O4 and NiO.

6. The filter of claim 1, further comprising a layer formed from mixed oxides and located between the first layer and another layer of the filter.

7. A method for producing the filter of claim 1, comprising applying a suspension comprising a metal oxide material onto a previously-formed layer of the filter and subsequently sintering the metal oxide material in the suspension.

8. The method of claim 7, wherein the suspension comprising a metal oxide material is sprayed onto the previously-formed layer of the filter.

9. The method of claim 7, wherein the previously-formed layer is produced by spraying a suspension comprising sinterable materials and subsequently sintering the sinterable materials in the suspension.

10. The method of claim 7, wherein the previously-formed layer is smoothed mechanically before the suspension comprising a metal oxide material is applied.

11. The method of claim 7, wherein the suspension comprising a metal oxide material further comprises at least one of a solvent, a binding agent, a stabilizer, and a dispersing agent.

12. The method of claim 11, wherein the solvent is selected from a group comprising water, methanol, ethanol, isopropanol, terpenes, C2-C5-alkenes, toluenes, trichlorethylenes, diethyl ether, C1-C6-aldehydes, and ketones.

13. The method of claim 11, wherein the binding agent is selected from a group comprising polyvinyl acetate, waxes, shellac, polyethylene oxides, and polyglycoles.

14. The of claim 11, wherein the stabilizer is selected from a group comprising organic acids, inorganic acids, inorganic lyes, polyacrylamides, polyacryl acid, and amines.

15. The of claim 11, wherein the dispersing agent is selected from a group comprising polyamines, phthalic ester, and polyethylenemines.
